(19) United States
(12) Patent Application Publication
(10) Pub. No.: US 2015/0328772 A1
(43) Pub. Date: Nov. 19, 2015

(54) METHOD, APPARATUS, AND MEDIUM FOR PROGRAMMING INDUSTRIAL ROBOT

(71) Applicant: Yaskawa America, Inc., Waukegan, IL (US)

(72) Inventor: Kei KATO, Wheeling, IL (US)

(73) Assignee: Yaskawa America, Inc., Waukegan, IL (US)

(21) Appl. No.: 14/277,072

(22) Filed: May 14, 2014

(51) Int. Cl. B25J 9/16

(52) U.S. Cl. CPC B25J 9/1661; B25J 9/1664

(57) ABSTRACT

A method for programming an industrial robot, which includes providing a processing operation that is divided into a plurality of layers, and providing, via a processing unit, for selection among predetermined selections in each layer of the plurality of layers to program the processing operation. An apparatus for programming an industrial robot that includes a processing unit configured to provide a processing operation that is divided into a plurality of layers, where the processing unit is configured to provide for selection among predetermined selections in each layer of the plurality of layers to program the processing operation.

### BACKGROUND OF THE INVENTION

1. Field of the Invention

The present invention relates to a method, an apparatus, and a medium for programming an industrial robot.

2. Discussion of the Background

One manner in which industrial robots are conventional programmed involves a computer programmer writing computer code to define handling operations of the robot.

Alternative conventional methods used to program industrial robots include a process in which a technician manually manipulates the robot to various desired positions and stores such positions in order to manually construct the handling operation.

### SUMMARY OF THE INVENTION

The present invention advantageously provides a method for programming an industrial robot, where the method includes providing a processing operation that is divided into a plurality of layers, and providing, via a processing unit, for selection among predetermined selections in each layer of the plurality of layers to program the processing operation.

The present invention also advantageously provides an apparatus for programming an industrial robot, where the apparatus includes a processing unit configured to provide a processing operation that is divided into a plurality of layers, where the processing unit is configured to provide for selection among predetermined selections in each layer of the plurality of layers to program the processing operation.

The present invention further advantageously provides an apparatus for programming an industrial robot, where the apparatus includes means for providing a processing operation that is divided into a plurality of layers, and means for providing for selection among predetermined selections in each layer of the plurality of layers to program the processing operation.

The present invention additionally advantageously provides a non-transitory computer readable medium storing a program which, when executed by one or more processing units, causes an apparatus to: provide a processing operation that is divided into a plurality of layers; and provide, via a processing unit, for selection among predetermined selections in each layer of the plurality of layers to program the processing operation.

The present invention further advantageously provides a method for programming an industrial robot, where the method includes providing a processing operation that is divided into a plurality of categories, and providing, via a processing unit, for selection among predetermined selections in each category of the plurality of categories to program the processing operation.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a diagram of a system or apparatus that can be used to teach and/or program one or more robots to perform processing operation(s), and to control the one or more robots to perform the processing operation(s);

FIG. 2 is a display on a display screen that shows a layered or category based approach to programming/teaching a robot, in which a 1^{st} Layer or Line Layer is shown;

FIG. 3 is a display on a display screen that shows a layered or category based approach to programming/teaching a robot, in which a 2^{nd} Layer or Item Layer is shown;

FIG. 4 is a display on a display screen that shows a layered or category based approach to programming/teaching a robot, in which a 3^{rd} Layer or Processing Station Layer is shown;

FIG. 5 is a display on a display screen that shows a layered or category based approach to programming/teaching a robot, in which a 4^{th} Layer or Handling Operation Layer is shown;

FIG. 6 is a display on a display screen that shows a layered or category based approach to programming/teaching a robot, in which a 5^{th} Layer or Motion Control Layer is shown;

FIG. 7 is a display on a display screen that utilizes symbols to teach/program a robot, in which a 1^{st} Layer or Line Layer is shown with a selection field;

FIG. 8 is a display on a display screen that utilizes symbols to teach/program a robot, in which a 1^{st} Layer or Line Layer is shown with a selection field and a programming field;

FIG. 9 is a display on a display screen that utilizes symbols to teach/program a robot, in which a 2^{nd} Layer or Item Layer is shown with a selection field;

FIG. 10 is a display on a display screen that utilizes symbols to teach/program a robot, in which a 2^{nd} Layer or Item Layer is shown with a selection field and a programming field;

FIG. 11 is a display on a display screen that utilizes symbols to teach/program a robot, in which a 3^{rd} Layer or Processing Station Layer is shown with a selection field;

FIG. 12 is a display on a display screen that utilizes symbols to teach/program a robot, in which a 3^{rd} Layer or Processing Station Layer is shown with a selection field and a programming field;

FIG. 13 is a display on a display screen that utilizes symbols to teach/program a robot, in which a 4^{th} Layer or Handling Operation Layer is shown; and

FIG. 14 is a display on a display screen that utilizes symbols to teach/program a robot, in which a 5^{th} Layer or Motion Control Layer is shown.

### DETAILED DESCRIPTION OF EXEMPLARY EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

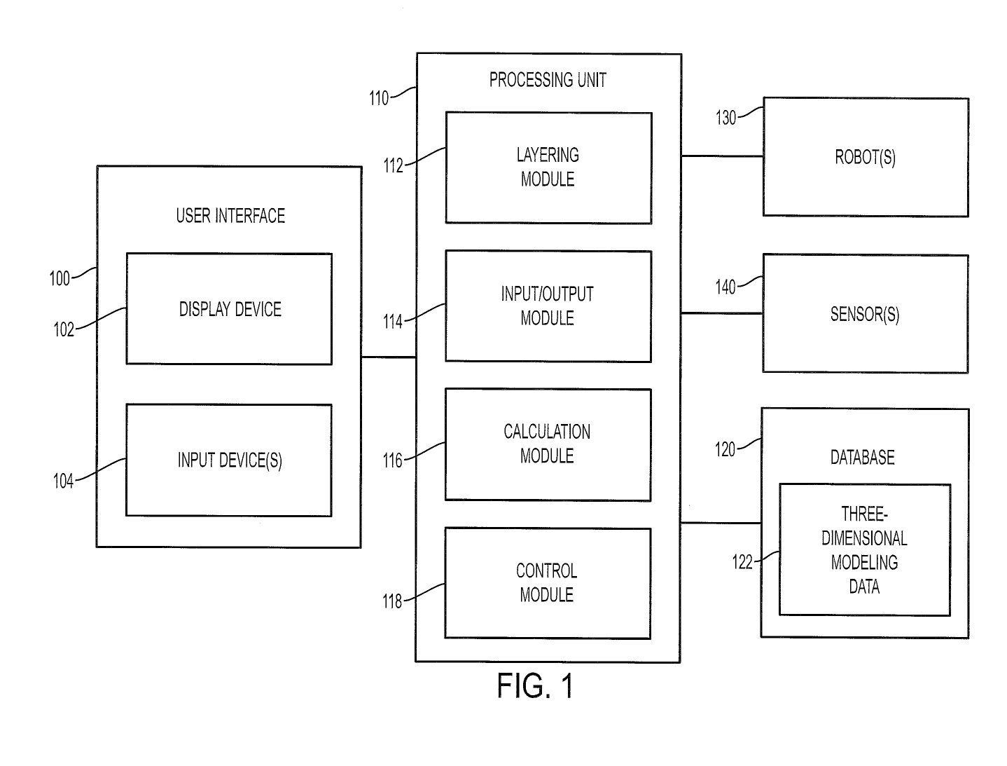

FIG. 1 depicts an apparatus or system that can be used to teach and/or program one or more robots to perform processing operation(s), and to control the one or more robots to perform the processing operation(s). For example, the system can be used at a manufacturing plant to teach and/or program industrial robot(s) to perform various processing operations on various items in order to produce products. FIG. 1 depicts a user interface 100, a processing unit 110, a database 120, robot(s) 130, and sensors 140. The user interface 100 allows a user or programmer to interact with the system, for example, by inputting various commands, data, etc. during teaching, programming, and/or operation of the system.

The user interface 100, the processing unit 110, the database 120, the robot(s) 130, and the sensors 140 can be incorporated within a single structural unit, or in two or more structural units. Also, the user interface 100, the processing unit 110, the database 120, the robot(s) 130, and the sensors 140 can communicate with one another via wired or wireless technology. For example, the user interface 100, the processing unit 110, and the database 120 can all be provided within a computing device, such as a mobile computing device (e.g., a laptop, tablet, smartphone, etc.), or a desktop computer or other stationary computing system. Another example can provide the user interface 100 and the processing unit 110 in a computing device that communicates using wireless or wired technology with the database 120. Another example can provide the user interface 100 in a separate computing device that communicates using wireless or wired technology with the processing unit 110 and the database 120 using a communication network. One or more of the user interface 100, the processing unit 110, and the database 120 can be incorporated into the robot(s) 130, or provided separately therefrom. The sensor(s) 140 can be provided separate from the other components, incorporated into the robot(s) 130, or incorporated in part or wholly into one or more of the user interface 100, the processing unit 110, and the database 120.

The user interface 100 shown in FIG. 1 includes a display device 102 and one or more input devices 104. The display device 102 can include a display screen, and can further include an audio output device. The input device(s) 104 can include any type of input device, such as a keyboard, mouse, touchscreen technology built into the display device 102, audio input (e.g., with audio recognition), etc. The user interface 100 can be provided in the form of a computing device, such as a mobile computing device (e.g., a laptop, tablet, smartphone, etc.), or a desktop computer or other stationary computing system. The user interface 100 can utilize wired or wireless technology to communicate with the processing unit 110, and other components of the system.

The user interface 100 allows a user or programmer to interact with the system, for example, by inputting various commands, data, etc. during teaching, programming, and/or operation of the system. For example, the user interface 100 can be provided in a tablet computing device, and the user can easily move throughout the plant to program and/or teach a robot to perform various processing operations. Such a user interface will allow the user to easily interact with the system during programming, teaching, testing, and operating of the robot.

The processing unit 110 depicted in FIG. 1 includes a layering module 112, an input/output module 114, a calculation module 116, and a control module 118. As will be discussed in greater detail below, the layering module 112 provides a layered or category based approach to programming and/or teaching the robot, which allows for complex programming and/or teaching in a simplified and easy-to-use manner. The input/output module 114 provides for communication with the other modules of the processing unit 110, as well as with the user interface 100, the database 120, the robot(s), and the sensor(s). For example, the input/output module 114 receives input data from the user interface 100 (e.g., from the input device(s) 104), and outputs data to the user interface 100 (e.g., sends data to display device 102). The calculation module 116 performs calculations based on inputs to the system. For example, the calculation module 116 can receive input data from the user interface 100, utilize or compile the input data to formulate a processing operation, and calculate movement of the robot(s) based on such information. The control module 118 can utilize the calculations performed by the calculation module 116 to control the robot(s) during the processing operations. The control module 118 can also control the processing and operation of the processing unit 110, as well as the other components of the system, such as the user interface 100, the database 120, the robot(s) 130, and the sensor(s) 140.

The processing unit 110 includes one or more processors that are used to perform the functions described herein in conjunction with one or more programs stored on non-transitory computer readable medium.

The database 120 depicted in FIG. 1 is a memory storage device that communicates with the processing unit 110. The database 120 can store any data used during the operation of the processing unit 110, as well as the user interface 100, the robot(s) 130, and the sensor(s) 140. The database 120 can include modeling data, such as two-dimensional modeling or three-dimensional modeling data 122, that can be used to teach, program, and/or operate the robot(s) 130. For example, two-dimensional modeling or three-dimensional modeling data of a manufacturing plant can be created and stored for use during planning of the movements of the robot 130 during processing operations. For example, a floor layout of the manufacturing plant including the location, shape, etc., of various manufacturing lines, processing stations, tools, etc., can be created using two-dimensional modeling or three-dimensional modeling (e.g., computer-aided design (CAD)), which can be used to plan the movements of the robot. Also, two-dimensional modeling or three-dimensional modeling data of the robot and of any item being processed during the processing operations can also be created and stored for use by the system.

The robot(s) 130 depicted in FIG. 1 can be any type of robot used to perform processing operations, such as an industrial robot. The robot(s) 130 can include one or more arm(s), joint(s), end effector(s)(e.g., hand, finger(s), tool, tool grasping device, etc.), etc. that allow the robot to perform various operations. The robot(s) 130 can be provided at a fixed, stationary location in the manufacturing plant, or can be movable about the manufacturing plant or area within the plant.

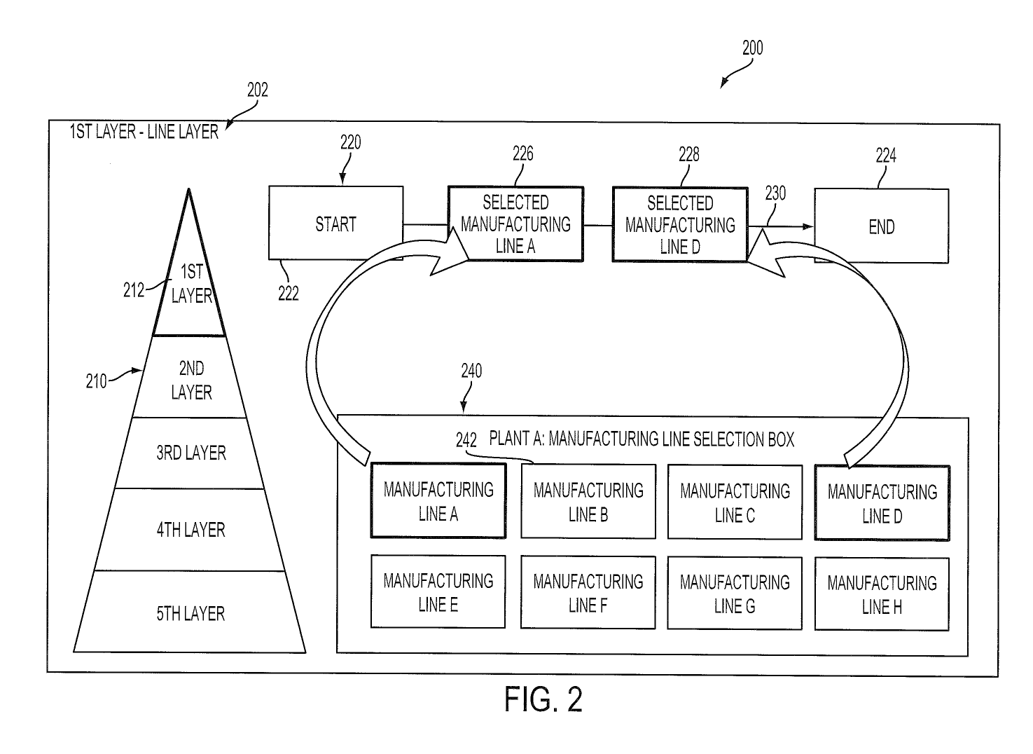

FIGS. 2-6 depict an apparatus and method for programming and/or teaching an industrial robot. The apparatus and method provide a layered or category based approach to programming the robot, which allows for complex programming in a simplified and easy-to-use manner.

FIG. 2 depicts a display 200 on a display screen that shows such a layered or category based approach to programming a robot. The display 200 can be provided, for example, on the display device 102 of the user interface 100 in FIG. 1. It is noted that the terms layer and category are used interchangeably herein, and the terms teach and program are used interchangeably herein.

The display 200 includes a layer indicia 202 including a label that describes a layer that is currently being displayed. In this depiction, the layer indicia 202 indicate that a 1^{St} Layer or Line Layer is being depicted. The display 200 further includes an overview indicia 210 that depict all of the layers, with a currently viewed layer 212 shown using a visual effect that is different from the non-current layers. The visual effect can be one or more of a change in size, change in font of text, bolding of text, italics of text, underlining of text, highlighting, change of color, flashing, zooming in, zooming out, gradation, shadowing, outlining, etc. In FIG. 2, the overview indicia 210 indicate that there are five layers; however, any number of layers can be used, as desire for the system being programmed. Also, the shape of the overview indicia 210 can be a different from the triangular shape shown in FIG. 2. The triangular shape shown in FIG. 2 was selected to signify that each layer has greater and greater detail as the user moves from the 1^{st} Layer to the 5^{th} Layer, thus the overview indicia 210 moves from a narrower layer to a wider layer. However, such a broadening arrangement is not necessary, and therefore a different indicia can be used that is more representative of the layered arrangement.

The display 200 in FIG. 2 further includes a programming field or area 220 and a selection field or area 240. The selection field 240 in FIG. 2 indicates the available manufacturing line selections within the manufacturing plant. For example, selection field 240 in FIG. 2 shows a manufacturing selection box for Plant A, which includes Manufacturing Lines A-H. Each manufacturing line is shown using a symbol or icon 242. Each manufacturing line can represent different manufacturing lines, such as, for example, an engine assembly line, or a preparation and painting line, or semiconductor processing line, etc., etc. Thus, a user can select one or more desired manufacturing lines from the selection field 240 and insert such selected manufacturing lines into the programming field 220 in order to define a sequential process at the line layer.

Thus, the programming field 220 is initially provided with a start symbol or icon 222 and an end symbol or icon 224. Then, the programmer can select one or more manufacturing lines from the selection field 240 and insert such selected manufacturing lines into the programming field 220. As can be seen from the large arrows in FIG. 2, Manufacturing Line A has been selected and inserted into the programming field 220 at symbol or icon 226, and Manufacturing Line D has been selected and inserted into the programming field 220 at symbol or icon 228. The user has arranged Selected Manufacturing Line A to be performed first, and Selected Manufacturing Line D to be performed second sequentially, and thus the programming field 220 shows the process proceeding along process line 230. The selected manufacturing lines can be changed if desired, and the sequential arrangement can be changed if desired.

The selections from the selection field 240 into the programming field 220 can be made using a drag-and-drop operation, or other selection process (e.g., double-clicking on a mouse, right-clicking on a mouse, ENTER button, designated button(s), etc.). As can be seen in FIG. 2, the manufacturing lines that are selected are shown in the selection field 240 using a visual effect that is different from the non-selected manufacturing lines. The visual effect can be one or more of a change in size, change in font of text, bolding of text, italics of text, underlining of text, highlighting, change of color, flashing, zooming in, zooming out, gradation, shadowing, outlining, etc. Also, the visual effect in the selection field 240 can match a visual effect used to depict the selected manufacturing lines in the programming field 220.

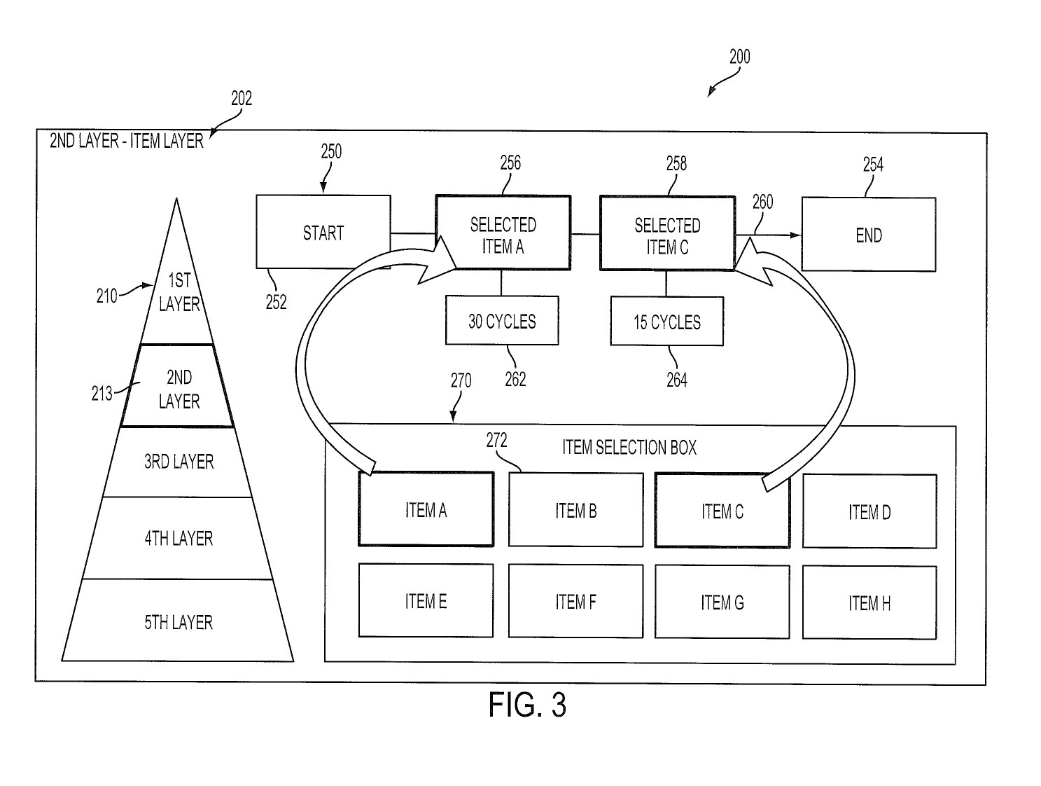

Once the 1^{st} Layer or Line Layer is defined by the user, then the user can proceed to define the other layers. For example, the user can select one of the other layers shown in overview indicia 210. For example, if the user selected the 2^{nd} Layer in the overview indicia 210, then the display 200 will display the 2^{nd} Layer or Item Layer shown in FIG. 3.

FIG. 3 depicts the display 200 including the layer indicia 202. In this depiction, the layer indicia 202 indicate that a 2^{nd} Layer or Item Layer is being depicted. The display 200 again includes the overview indicia 210 that depict all of the layers, with the currently viewed layer 213 shown using a visual effect that is different from the non-current layers. The display 200 in FIG. 3 further includes a programming field or area 250 and a selection field or area 270.

The selection field 270 in FIG. 3 indicates the available item selections. The items can include one or more items on which the processing operations are being performed. The processing operation can be defined such that each selected item is processed individually or in combination with one or more other such items, or is processed in combination with one or more other selected items. For example, selection field 270 in FIG. 3 shows an item selection box, which includes Items A-H. Each item is shown using a symbol or icon 272. Thus, a user can select one or more desired items from the selection field 270 and insert such selected items into the programming field 250 in order to define a sequential process at the item layer.

Thus, the programming field 250 is initially provided with a start symbol or icon 252 and an end symbol or icon 254. Then, the user can select one or more items from the selection field 270 and insert such selected items into the programming field 250. As can be seen from the large arrows in FIG. 3, Item A has been selected and inserted into the programming field 250 at symbol or icon 256, and Item C has been selected and inserted into the programming field 250 at symbol or icon 258. The user has arranged Selected Item A to be processed first, and Selected Item C to be processed second sequentially, and thus the programming field 250 shows the process proceeding along process line 260. The programming field 250 also allows the user to define a number of cycles that relate to the selected item. For example, such a cycle designation can represent a number of processes that are performed on each item (e.g., each selected item receives three painting processes to provide three layers of paint on each item), or a number of items of the selected item type on which the defined process is performed (e.g., ten of the selected items each receives one painting process to provide one layer of paint on each of the ten items). Thus, the user can enter a number of cycles for Selected Item A into cycle box 262, and enter a number of cycles for Selected Item C into cycle box 264. The selected items and cycles can be changed if desired, and the sequential arrangement can be changed if desired.

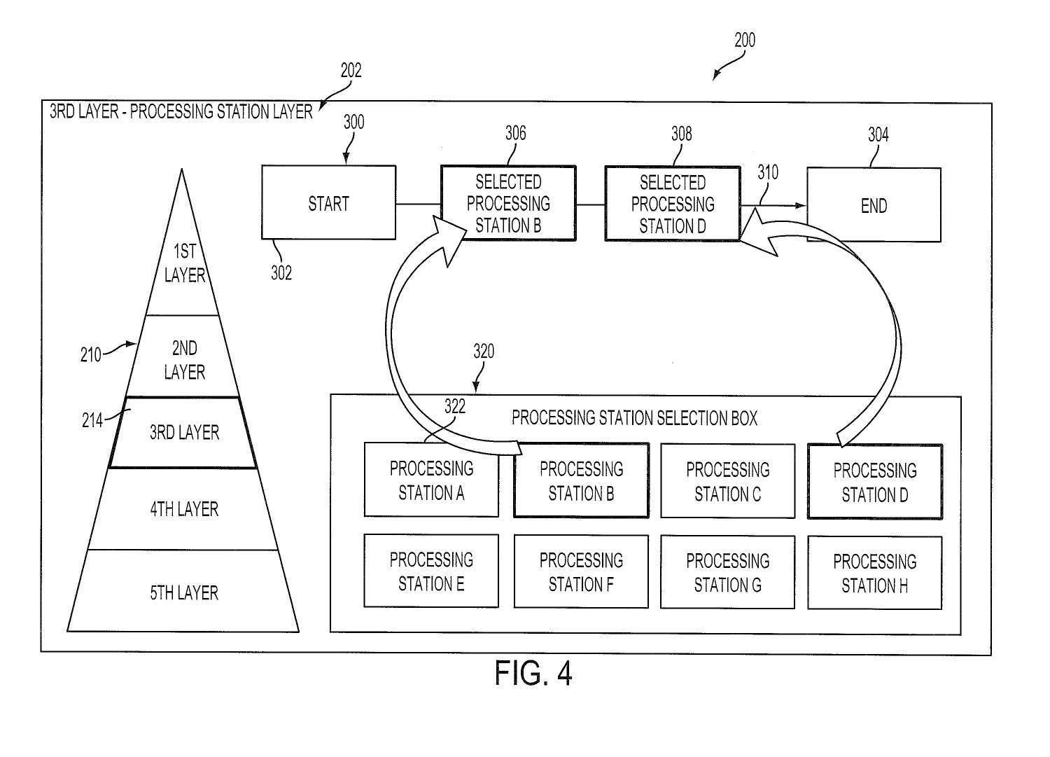

The user can define the 3^{rd} Layer by, for example, selecting the 3^{rd} Layer in the overview indicia 210, then the display 200 will display the 3^{rd} Layer or Processing Station Layer shown in FIG. 4.

FIG. 4 depicts the display 200 including the layer indicia 202. In this depiction, the layer indicia 202 indicate that a 3^{rd} Layer or Processing Station Layer is being depicted. The display 200 again includes the overview indicia 210 that depict all of the layers, with the currently viewed layer 214 shown using a visual effect that is different from the non-current layers. The display 200 in FIG. 4 further includes a programming field or area 300 and a selection field or area 320.

The selection field 320 in FIG. 4 indicates the available processing station selections. For example, the available processing stations shown in the selection field 320 can correspond to one or more of the selected manufacturing lines in programming field 220 in FIG. 2. If desired, the display 200 can include in the 3^{rd} Layer or Processing Station Layer display a separate programming field and/or selection field for each of the selected manufacturing lines. Each processing station can represent a processing device that can be used to perform one or more processes on the selected item(s). The selection field 320 in FIG. 4 shows a processing station selection box, which includes Processing Stations A-H. Each processing station is shown using a symbol or icon 322. Thus, a user can select one or more desired processing stations from the selection field 320 and insert such selected processing stations into the programming field 300 in order to define a sequential process at the processing station layer.

Thus, the programming field 300 is initially provided with a start symbol or icon 302 and an end symbol or icon 304. Then, the user can select one or more processing stations from the selection field 320 and insert such selected processing stations into the programming field 300. As can be seen from the large arrows in FIG. 4, Processing Station B has been selected and inserted into the programming field 300 at symbol or icon 306, and Processing Station D has been selected and inserted into the programming field 300 at symbol or icon 308. The user has arranged Processing Station B to be utilized first, and Processing Station D to be utilized second sequentially, and thus the programming field 300 shows the process proceeding along process line 310. The selected processing stations can be changed if desired, and the sequential arrangement can be changed if desired.

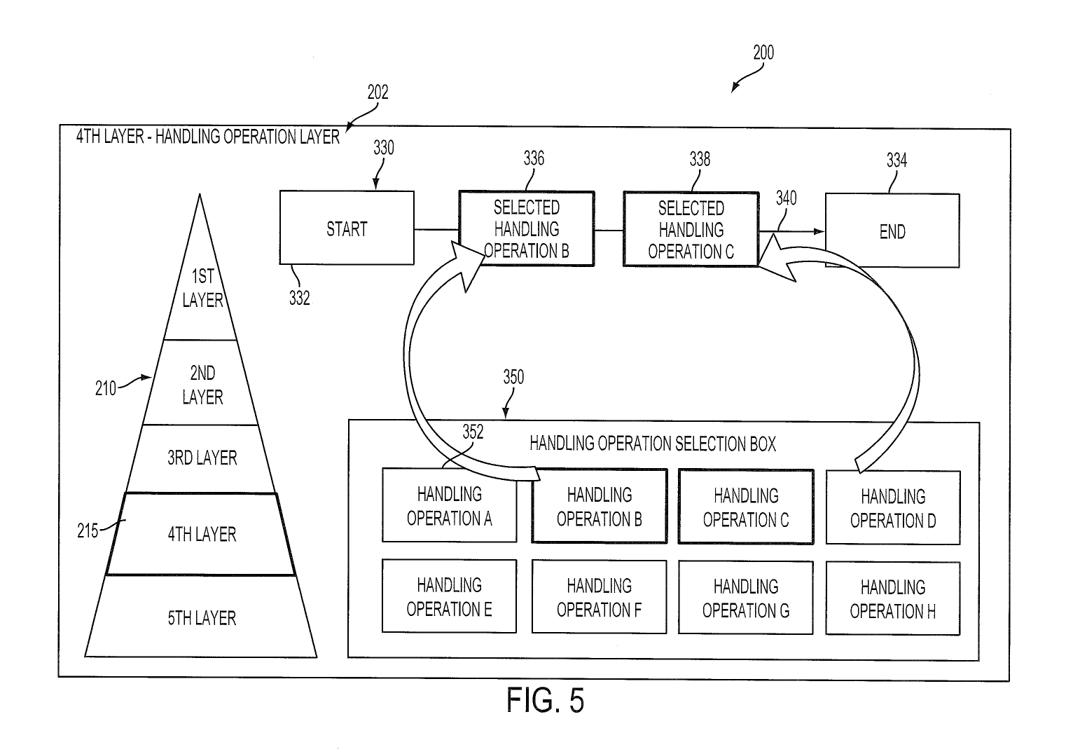

The user can define the 4^{th} Layer by, for example, selecting the 4^{th} Layer in the overview indicia 210, then the display 200 will display the 4^{th} Layer or Handling Operation Layer shown in FIG. 5.

FIG. 5 depicts the display 200 including the layer indicia 202. In this depiction, the layer indicia 202 indicate that a 4^{th} Layer or Handling Operation Layer is being depicted. The display 200 again includes the overview indicia 210 that depict all of the layers, with the currently viewed layer 215 shown using a visual effect that is different from the non-current layers. The display 200 in FIG. 5 further includes a programming field or area 330 and a selection field or area 350.

The selection field 350 in FIG. 5 indicates the available handling operation selections. For example, the available handling operations shown in the selection field 350 can correspond to movements of the robot(s) at or between one or more of the selected processing stations in programming field 300 in FIG. 4. If desired, the display 200 can include in the 4^{th} Layer or Handling Operation Layer display a separate programming field and/or selection field for each of the selected processing stations. Each handling operation can represent a movement of the robot (e.g., movement of the robot from point-to-point, picking-up movement of the robot where the robot picks an item up, putting-down movement of the robot where the robot puts the item down, etc.) that the robot can perform with relation to the item during the processing operation. The handling operations can be performed by the robot on the selected item at a selected processing station, between selected processing stations, or between selected manufacturing lines.

The selection field 350 in FIG. 5 shows a handling operation selection box, which includes Handling Operations A-H. Each handling operation is shown using a symbol or icon 352. Thus, a user can select one or more desired handling operations from the selection field 350 and insert such selected handling operations into the programming field 330 in order to define a sequential process performed by the robot on the item.

Thus, the programming field 330 is initially provided with a start symbol or icon 332 and an end symbol or icon 334. Then, the user can select one or more handling operations from the selection field 350 and insert such selected handling operations into the programming field 330. As can be seen from the large arrows in FIG. 5, Handling Operation B has been selected and inserted into the programming field 300 at symbol or icon 336, and Handling Operation C has been selected and inserted into the programming field 300 at symbol or icon 338. The user has arranged Handling Operation B to be performed first, and Handling Operation C to be performed second sequentially, and thus the programming field 320 shows the process proceeding along process line 340. The selected handling operations can be changed if desired, and the sequential arrangement can be changed if desired.

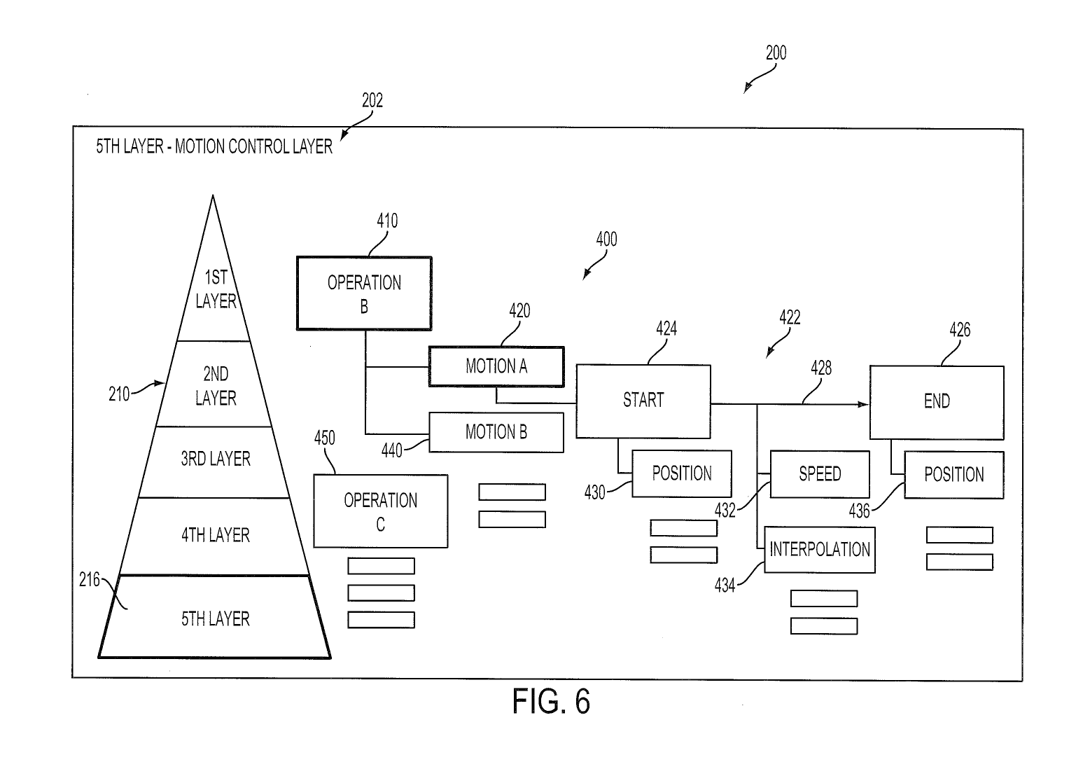

The user can define the 5^{th} Layer by, for example, selecting the 5^{th} Layer in the overview indicia 210, then the display 200 will display the 5^{th} Layer or Motion Control Layer shown in FIG. 6.

FIG. 6 depicts the display 200 including the layer indicia 202. In this depiction, the layer indicia 202 indicate that a 5^{th} Layer or motion Control Layer is being depicted. The display 200 again includes the overview indicia 210 that depict all of the layers, with the currently viewed layer 216 shown using a visual effect that is different from the non-current layers. The display 200 in FIG. 6 further includes a programming field or area 400 with various selection menus.

The programming field 400 includes the selected handling operations from the programming field 330 in FIG. 5. Thus, in FIG. 6, a first selected handling operation field 410 is provided for Selected Handling Operation B, and a second selected handling operation field 450 is provided for Selected Handling Operation C. The user can then define the motion controls associated with a selected handling operation by selecting a handling operation to open a menu tree, as can be seen with the first selected handling operation field 410 shown in FIG. 6. Thus, as can be seen in FIG. 6, the first selected handling operation field 410 has been selected as indicated using visual effect, which reveals Motion A 420 and Motion B 440, and Motion A 420 has also been selected as indicated using visual effect, which reveals a programming field 422 for Motion A 420.

The programming field 422 allows the user to define specific characteristics of Motion A 420. The programming field 422 includes a start 424 of the handling operation that includes a drop-down menu 430 that can be used to define a start position, and an end 426 of the handling operation that includes a drop-down menu 436 that can be used to define an end position. Additionally, the programming field 422 also includes a process line 428 that defines the actions or movements of the robot between the start and end of the motion of the handling operation. For example, the process line 428 of Motion A 420 includes a speed menu 432 and an interpolation menu 434. The various drop-down menus can be used by the user to input data to define the various motions of the robot. In this manner, the user can define Motion A 420 and Motion B 440 that are used to define various parameters used during Selected Handling Operation B. Thus, the user can select the various operation handling symbols (e.g., Operation B 410, Operation C 450), the various motion symbols (e.g., Motion A 420, Motion B 440), and the various drop-down menus (e.g., 430, 432, 434, 436) to precisely define the handling operations of the robot.

Accordingly, a method and apparatus is provided that provides a processing operation that is divided into a plurality of layers or categories, and provides, via a processing unit, for selection among predetermined selections in each layer or category of the plurality of layers or categories to program the processing operation. For example, the layering module 112 of the processing unit 110 can be used by an initial programmer to define the various desired layers or categories, such that the input/output module 114 of the processing unit 110 can present the layered displays in FIGS. 2-6 to a process programmer via the user interface 100, such that the process programmer can define the processing operation. By providing the processing operation that is divided into layers or categories, the process programmer can define a complex processing operation in an easy and intuitive manner Once the processing programmer inputs the data in the manner shown in FIGS. 2-6 via the user interface 100, the calculation module 116 can receive the input data from the user interface 100, utilize or compile the input data to formulate a processing operation, and calculate movement of the robot(s) based on such information. If desired, the calculation module 116 can also use the two-dimensional modeling or three-dimensional modeling data 122 during such calculations. For example, the processing unit 110 can be further configured to calculate movement of the industrial robot during the selected handling operation using predetermined two-dimensional modeling or three-dimensional modeling data in conjunction with the selected motion control. The control module 118 can then utilize the calculations performed by the calculation module 116 to control the robot(s) 130 during the processing operations.

It is noted that the embodiment described above with respect to FIGS. 1-6 includes five categories or layer; however, any number of categories or layers can be used. For example, a method and apparatus can be provided that provides a processing operation that is divided into seven layers (or categories), in which the first layer displays a 2D (two-dimensional) or 3D (three-dimensional) mapped list of manufacturing factories in a world map that are operated by a manufacturing company, a second layer displays a 2D or 3D mapped list of factory buildings in the factory selected in the first layer, a third layer displays a 2D or 3D mapped list of product lines in a the factory building selected in the second layer, a fourth layer that displays a 2D or 3D modeling list of product items in the product line selected in the third layer, a fifth layer displays a 2D or 3D modeling list of product stations for manufacturing the item selected in the fourth layer in the product line selected in the third layer, a sixth layer that displays a visualized list of robot operations at the station selected in the fifth layer 5, and a seventh layer that displays a visualized list of robot motion controls selected in the sixth layer.

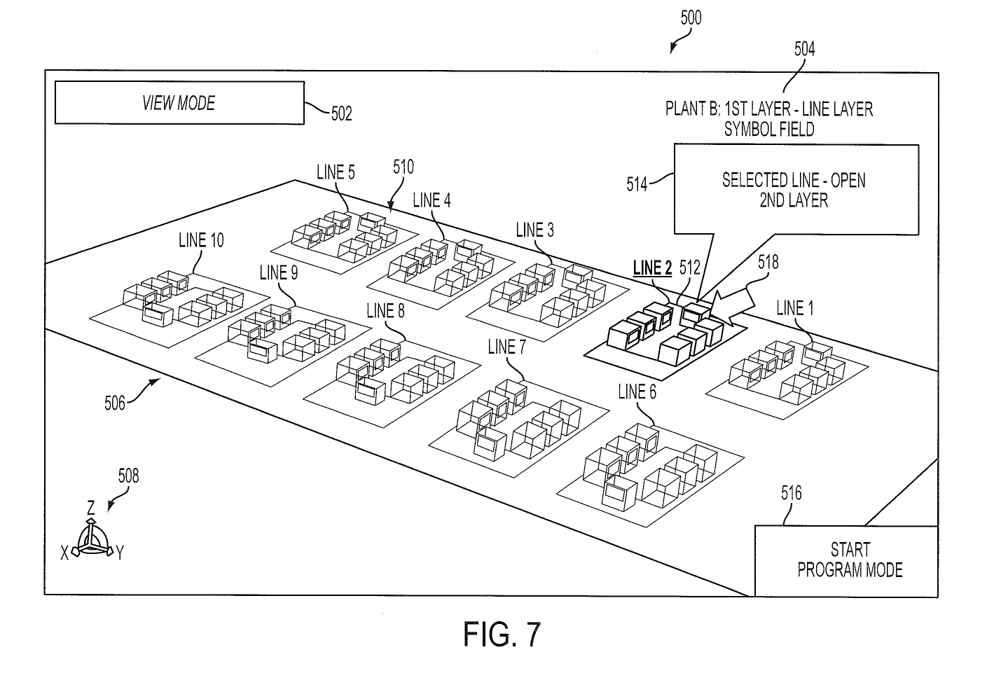

FIGS. 7-14 depict an apparatus and method for teaching and/or programming an industrial robot. The apparatus and method provide, on a user interface, symbols corresponding to input selections for teaching/programming an industrial robot a processing operation, which allows for complex teaching/programming in a simplified, intuitive, and easy-to-use manner

FIG. 7 depicts a display 500 on a display screen that shows an advantageous user interface used to teach/programming a robot. The display 500 can be provided, for example, on the display device 102 of the user interface 100 in FIG. 1. It is noted that the terms layer and category are used interchangeably herein, and the terms teach and program are used interchangeably herein.

The display 500 includes a mode indicia 502 indicating a mode that the display is currently in, and a layer indicia 504 including a label that describes a layer that is currently being displayed. In this depiction, the mode indicia 502 indicates a View Mode, which shows a single display area or symbol field, and the layer indicia 504 indicates that a 1^{st} Layer or Line Layer with a Symbol Field being depicted. The display 500 further includes a plant overview indicia 506 that depicts all of the manufacturing lines within the plant (i.e., Plant B, as noted in the layer indicia 504), and a coordinate symbol 508 showing the orientation of the plant overview. The user can rotate the orientation of the plant overview if desired. The symbol field shown in FIG. 7 shows a pictorial representation (i.e., plant overview indicia 506) of the plant (i.e., Plant B) including pictorial representations 510 of each of the manufacturing lines (i.e., Lines 1-10) in the plant.

The symbol field shown in FIG. 7 shows a currently selected manufacturing line (i.e., Line 2) 512 shown using a visual effect that is different from the non-selected lines. The visual effect can be one or more of a change in size, change in font of text, bolding of text, italics of text, underlining of text, highlighting, change of color, flashing, zooming in, zooming out, gradation, shadowing, outlining, etc. As noted in dialogue box 514, the currently selected manufacturing line 512 can be used to open a 2^{nd} Layer. For example, the user can perform an operation (e.g., double-click using a cursor controlled by a mouse, select on a touchscreen, etc.) on the currently selected manufacturing line 512 to open the 2^{nd} Layer, or the user can even select the dialogue box 514 to open the 2^{nd} Layer. If desired, the dialogue box 514 can be displayed on the display 500 in order to give the user helpful hints regarding how to navigate the user interface, or such dialogue boxes can be hidden or turned off by more advanced users if desired.

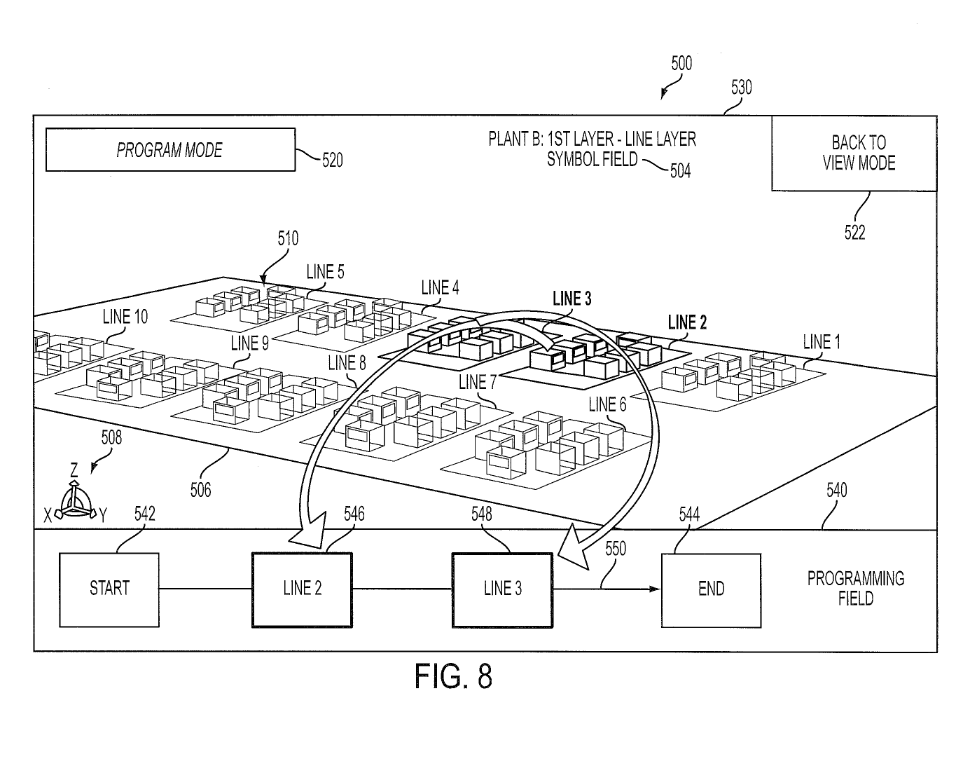

The display 500 includes a Start Program Mode button 516 that can be selected by the user in order to begin or access a programming field or area for the layer that is currently displayed. Once the user selects the Start Program Mode button 516, the display 500 displays the depiction shown in FIG. 8.

The display 500 includes a mode indicia 520 indicating a mode that the display is currently in, and the layer indicia 504 including a label that describes the layer that is currently being displayed. In this depiction, the mode indicia 502 indicates a Program Mode, which shows dual display areas or symbol fields, and the layer indicia 504 indicates that a 1^{st} Layer or Line Layer with the Symbol Field being depicted in one of the display areas. The display 500 also includes a Back to View Mode button 522 that would bring the display back to the View Mode shown in FIG. 7 when selected by the user.

The display 500 in FIG. 8 depicts the dual displays or areas as a selection field or area 530 and a programming field or area 540 for the 1^{st} Layer. The selection field 530 in FIG. 8 includes the pictorial representation of the plant with the available manufacturing line selections within the manufacturing plant. The selection field 530 can show a slightly reduced symbol field, as compared to the depiction in FIG. 7. The selection field 530 in FIG. 8 shows a pictorial representation of Plant B, which includes Manufacturing Lines 1-10. Each manufacturing line is shown using a symbol or icon 510. Each manufacturing line can represent different manufacturing lines, such as, for example, an engine assembly line, or a preparation and painting line, or semiconductor processing line, etc., etc. Thus, a user can select one or more desired manufacturing lines from the selection field 530 and insert such selected manufacturing lines into the programming field 540 in order to define a sequential process at the line layer.

Thus, the programming field 540 is initially provided with a start symbol or icon 542 and an end symbol or icon 544. Then, the user can select one or more manufacturing lines from the selection field 530 and insert such selected manufacturing lines into the programming field 540. As can be seen from the large arrows in FIG. 8, Manufacturing Line 2 has been selected and inserted into the programming field 540 at symbol or icon 546, and Manufacturing Line 3 has been selected and inserted into the programming field 540 at symbol or icon 548. The user has arranged Selected Manufacturing Line 2 to be performed first, and Selected Manufacturing Line 3 to be performed second sequentially, and thus the programming field 540 shows the process proceeding along process line 550. The selected manufacturing lines can be changed if desired, and the sequential arrangement can be changed if desired.

The selections from the selection field 530 into the programming field 540 can be made using a drag-and-drop operation, or other selection process (e.g., double-clicking on a mouse, right-clicking on a mouse, ENTER button, designated button(s), etc.). As can be seen in FIG. 8, the manufacturing lines that are selected are shown in the selection field 530 using a visual effect that is different from the non-selected manufacturing lines. The visual effect can be one or more of a change in size, change in font of text, bolding of text, italics of text, underlining of text, highlighting, change of color, flashing, zooming in, zooming out, gradation, shadowing, outlining, etc. Also, the visual effect in the selection field 530 can match a visual effect used to depict the selected manufacturing lines in the programming field 540.

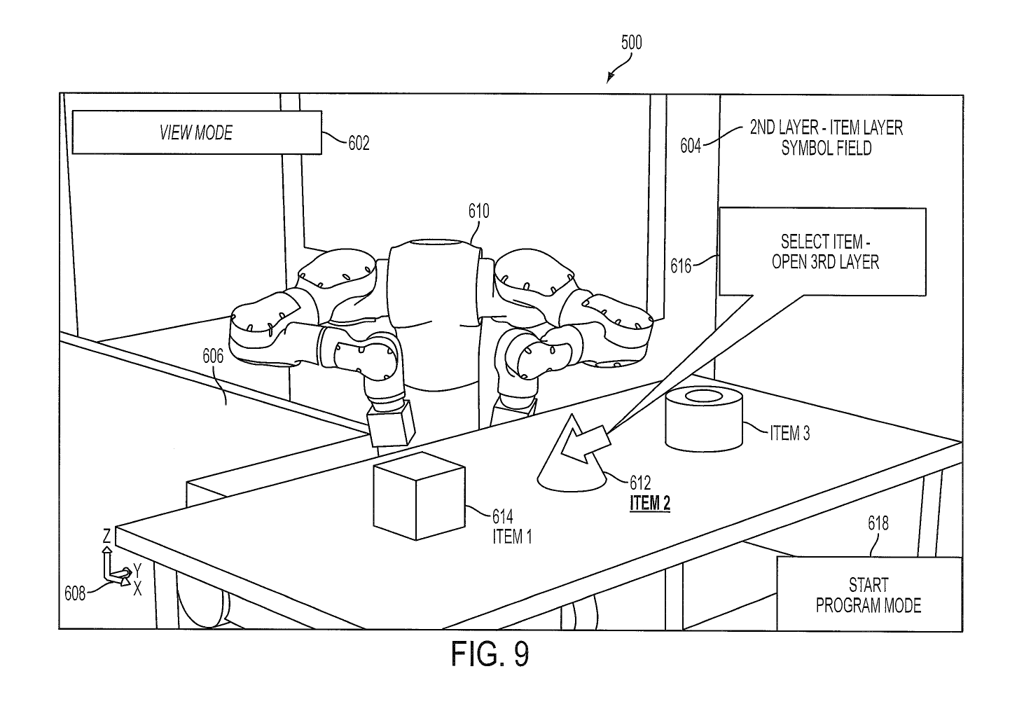

Once the 1^{st} Layer or Line Layer is defined by the user, then the user can proceed to define the other layers. For example, the user can return to the View Mode shown in FIG. 7 by selecting the Back to View Mode button 522, and then open the 2^{nd} Layer by performing an operation (e.g., double-click using a cursor controlled by a mouse, select on a touchscreen, etc.) on the currently selected manufacturing line 512, or by selecting the dialogue box 514. Then, the display 500 will display the 2^{nd} Layer or Item Layer shown in FIG. 9.

The display 500 shown in FIG. 9 includes a mode indicia 602 indicating a mode that the display is currently in, and a layer indicia 604 including a label that describes a layer that is currently being displayed. In this depiction, the mode indicia 602 indicates a View Mode, which shows a single display area or symbol field, and the layer indicia 604 indicates that a 2^{nd} Layer or Item Layer with a Symbol Field being depicted. The display 500 further includes an item overview indicia 606 that includes pictorial representations of all of the available items (i.e., Items 1-3) on which the processing operations can be performed. The display 500 further shows a coordinate symbol 608 showing the orientation of the item overview, a pictorial representation of a robot 610. The user can rotate the orientation of the item overview if desired.

The symbol field shown in FIG. 9 shows a currently selected item (i.e., Item 2) 612 shown using a visual effect that is different from the non-selected items 614. The visual effect can be one or more of a change in size, change in font of text, bolding of text, italics of text, underlining of text, highlighting, change of color, flashing, zooming in, zooming out, gradation, shadowing, outlining, etc. As noted in dialogue box 616, the currently selected item 612 can be used to open a 3^{rd} Layer.

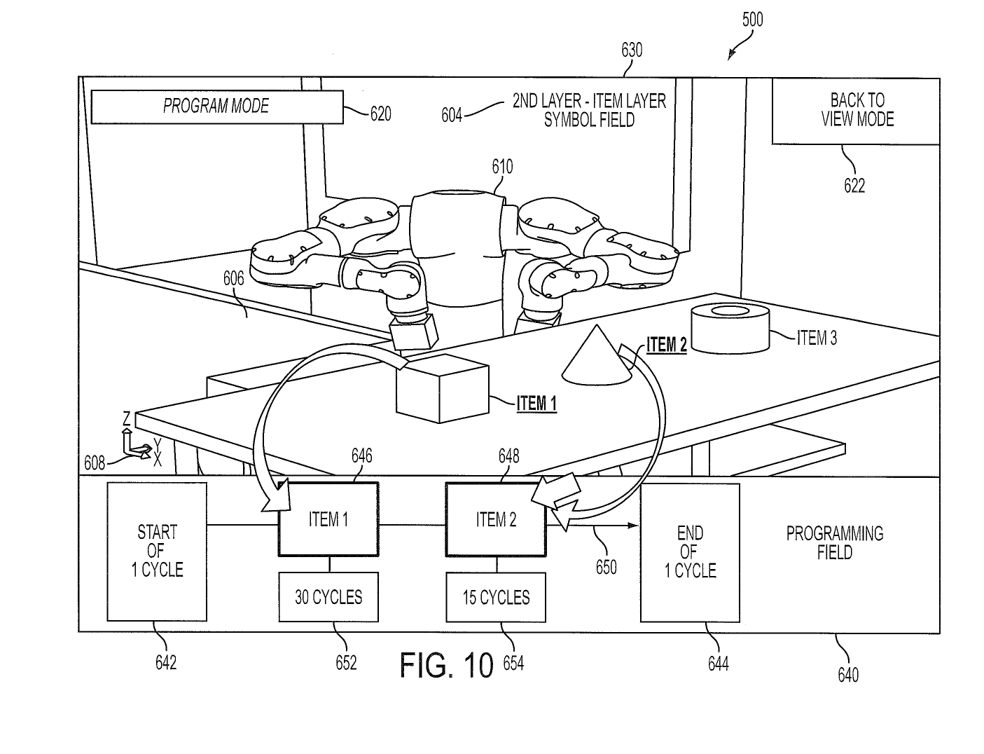

The display 500 includes a Start Program Mode button 618 that can be selected by the user in order to begin or access a programming field or area for the layer that is currently displayed. Once the user selects the Start Program Mode button 618, the display 500 displays the depiction shown in FIG. 10.

The display 500 includes a mode indicia 620 indicating a mode that the display is currently in, and the layer indicia 604 including a label that describes the layer that is currently being displayed. In this depiction, the mode indicia 620 indicates a Program Mode, which shows dual display areas or symbol fields, and the layer indicia 604 indicates that a 2^{nd} Layer or Item Layer with the Symbol Field being depicted in one of the display areas. The display 500 also includes a Back to View Mode button 622 that would bring the display back to the View Mode shown in FIG. 9 when selected by the user.

The display 500 in FIG. 10 depicts the dual displays or areas as a selection field or area 630 and a programming field or area 640 for the 2^{nd} Layer. The selection field 630 in FIG. 10 includes the pictorial representation of the available item selections within the selected manufacturing line. The selection field 630 can show a slightly reduced symbol field, as compared to the depiction in FIG. 9. The selection field 630 in FIG. 10 shows a pictorial representation that includes Items 1-3. The items can include one or more items on which the processing operations are being performed. The processing operation can be defined such that each selected item is processed individually or in combination with one or more other such items, or is processed in combination with one or more other selected items. Thus, a user can select one or more desired items from the selection field 630 and insert such selected items into the programming field 640 in order to define a sequential process at the item layer.

Thus, the programming field 640 is initially provided with a start symbol or icon 642 and an end symbol or icon 644. Then, the user can select one or more items from the selection field 630 and insert such selected items into the programming field 640. As can be seen from the large arrows in FIG. 10, Item 1 has been selected and inserted into the programming field 640 at symbol or icon 646, and Item 2 has been selected and inserted into the programming field 640 at symbol or icon 648. The user has arranged Selected Item 1 to be processed first, and Selected Item 2 to be processed second sequentially, and thus the programming field 640 shows the process proceeding along process line 650. The programming field 640 also allows the user to define a number of cycles that relate to the selected item. For example, such a cycle designation can represent a number of processes that are performed on each item (e.g., each selected item receives three painting processes to provide three layers of paint on each item), or a number of items of the selected item type on which the defined process is performed (e.g., ten of the selected items each receives one painting process to provide one layer of paint on each of the ten items). Thus, the user can enter a number of cycles for Selected Item 1 into cycle box 652, and enter a number of cycles for Selected Item 2 into cycle box 654. The selected items and cycles can be changed if desired, and the sequential arrangement can be changed if desired.

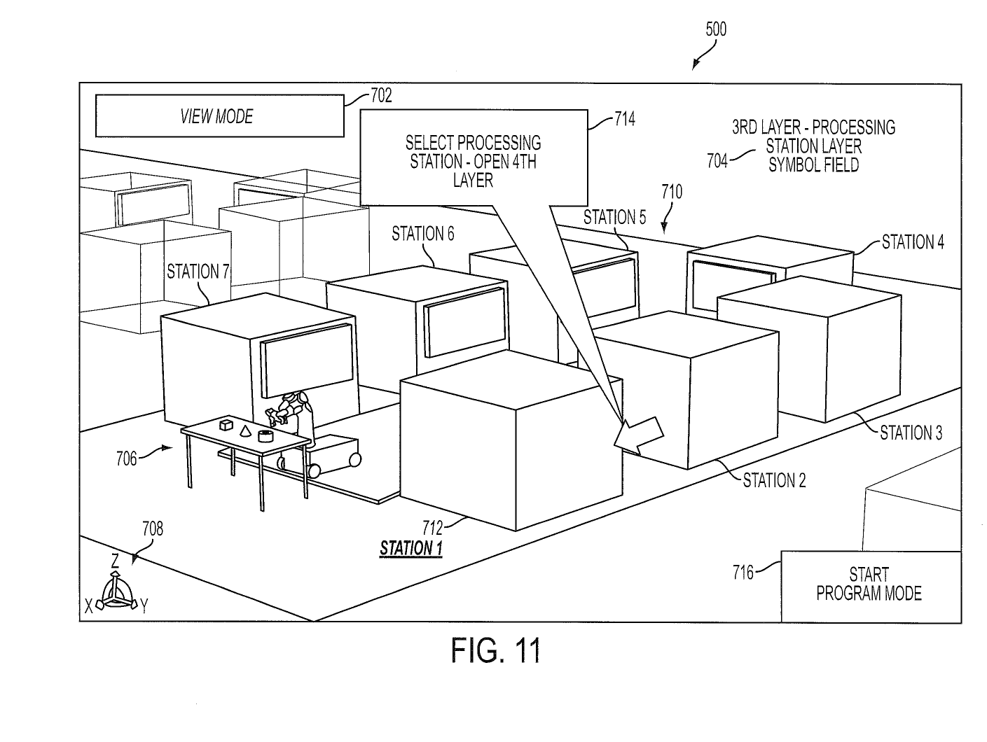

Once the 2^{nd} Layer or Item Layer is defined by the user, then the user can proceed to define the other layers. For example, the user can return to the View Mode shown in FIG. 9 by selecting the Back to View Mode button 622, and then open the 3^{rd} Layer by performing an operation (e.g., double-click using a cursor controlled by a mouse, select on a touchscreen, etc.) on the currently selected item 612, or by selecting the dialogue box 614. Then, the display 500 will display the 3^{rd} Layer or Processing Station Layer shown in FIG. 11. It is noted that the user can also move between the various layers by using, for example, a drop-down menu (e.g., by selecting a mode indicia button to open such a drop-down menu) or other selection means.

The display 500 shown in FIG. 11 includes a mode indicia 702 indicating a mode that the display is currently in, and a layer indicia 704 including a label that describes a layer that is currently being displayed. In this depiction, the mode indicia 702 indicates a View Mode, which shows a single display area or symbol field, and the layer indicia 704 indicates that a 3^{rd} Layer or Processing Station Layer with a Symbol Field being depicted. The display 500 further includes a processing station overview indicia 706 that depicts all of the processing stations within a selected manufacturing line within the plant, and a coordinate symbol 708 showing the orientation of the processing station overview. The user can rotate the orientation of the processing station overview if desired. The symbol field shown in FIG. 11 shows a pictorial representation (i.e., processing station overview indicia 706) of a selected manufacturing line including pictorial representations 710 of each of the processing stations (i.e., Stations 1-7) in the manufacturing line.

The symbol field shown in FIG. 11 shows a currently selected processing station (i.e., Station 1) 712 shown using a visual effect that is different from the non-selected lines. The visual effect can be one or more of a change in size, change in font of text, bolding of text, italics of text, underlining of text, highlighting, change of color, flashing, zooming in, zooming out, gradation, shadowing, outlining, etc. As noted in dialogue box 714, the currently selected processing station 712 can be used to open a 4^{th} Layer. For example, the user can perform an operation (e.g., double-click using a cursor controlled by a mouse, select on a touchscreen, etc.) on the currently selected processing station 712 to open the 4^{th} Layer, or the user can even select the dialogue box 714 to open the 4^{th} Layer.

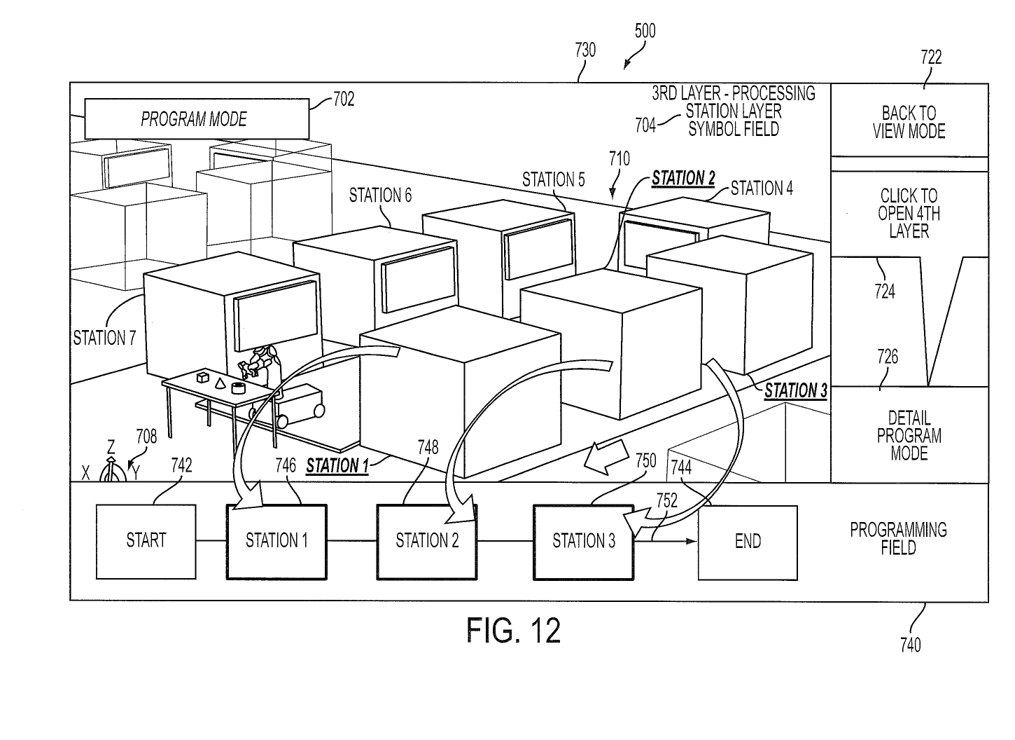

The display 500 includes a Start Program Mode button 716 that can be selected by the user in order to begin or access a programming field or area for the layer that is currently displayed. Once the user selects the Start Program Mode button 716, the display 500 displays the depiction shown in FIG. 12.

The display 500 includes a mode indicia 720 indicating a mode that the display is currently in, and the layer indicia 704 including a label that describes the layer that is currently being displayed. In this depiction, the mode indicia 702 indicates a Program Mode, which shows dual display areas or symbol fields, and the layer indicia 704 indicates that a 3^{rd} Layer or Processing Station Layer with the Symbol Field being depicted in one of the display areas. The display 500 also includes a Back to View Mode button 722 that would bring the display back to the View Mode shown in FIG. 11 when selected by the user, and a Detail Program Mode button 726 that would open the 4^{th} Layer, as noted in dialogue box 724.

The display 500 in FIG. 12 depicts the dual displays or areas as a selection field or area 730 and a programming field or area 740 for the 3^{rd} Layer. The selection field 730 in FIG. 12 includes the pictorial representation of the available processing station selections within the manufacturing line. The selection field 730 can show a slightly reduced symbol field, as compared to the depiction in FIG. 11. The selection field 730 in FIG. 12 shows a pictorial representation of Processing Stations 1-7. Each processing station is shown using a symbol or icon 710. Each processing station can represent different processing device(s) that can perform processing operations on selected items. Thus, a user can select one or more desired processing stations from the selection field 730 and insert such selected processing stations into the programming field 740 in order to define a sequential process at the processing station layer.

Thus, the programming field 740 is initially provided with a start symbol or icon 742 and an end symbol or icon 744. Then, the user can select one or more processing stations from the selection field 730 and insert such selected processing stations into the programming field 740. As can be seen from the large arrows in FIG. 12, Processing Station 1 has been selected and inserted into the programming field 740 at symbol or icon 746, Processing Station 2 has been selected and inserted into the programming field 740 at symbol or icon 748, and Processing Station 3 has been selected and inserted into the programming field 740 at symbol or icon 750. The user has arranged Selected Processing Station 1 to be performed first, Selected Processing Station 2 to be performed second sequentially, Selected Processing Station 3 to be performed third sequentially, and thus the programming field 740 shows the process proceeding along process line 752. The selected processing stations can be changed if desired, and the sequential arrangement can be changed if desired.

The selections from the selection field 730 into the programming field 740 can be made using a drag-and-drop operation, or other selection process (e.g., double-clicking on a mouse, right-clicking on a mouse, ENTER button, designated button(s), etc.). As can be seen in FIG. 12, the processing stations that are selected are shown in the selection field 730 using a visual effect that is different from the non-selected manufacturing lines. The visual effect can be one or more of a change in size, change in font of text, bolding of text, italics of text, underlining of text, highlighting, change of color, flashing, zooming in, zooming out, gradation, shadowing, outlining, etc. Also, the visual effect in the selection field 730 can match a visual effect used to depict the selected manufacturing lines in the programming field 740.

It is noted that, in the programming field 740 of FIG. 12, additional arrows can be provided along process line 752 in order to deal with various irregular operations (e.g., movements of the robot that do not follow an ideal (or intended) path, or when problems are encountered) that may be needed to teach the robot how to behave or move during such irregular operations. For example, the process line 752 can branch like the limbs of a tree from any location along the arrow of process line 752, for example, as in a case of a special operation needed to scrap a failed part encountered during the robot operation cycle at the manufacturing line.

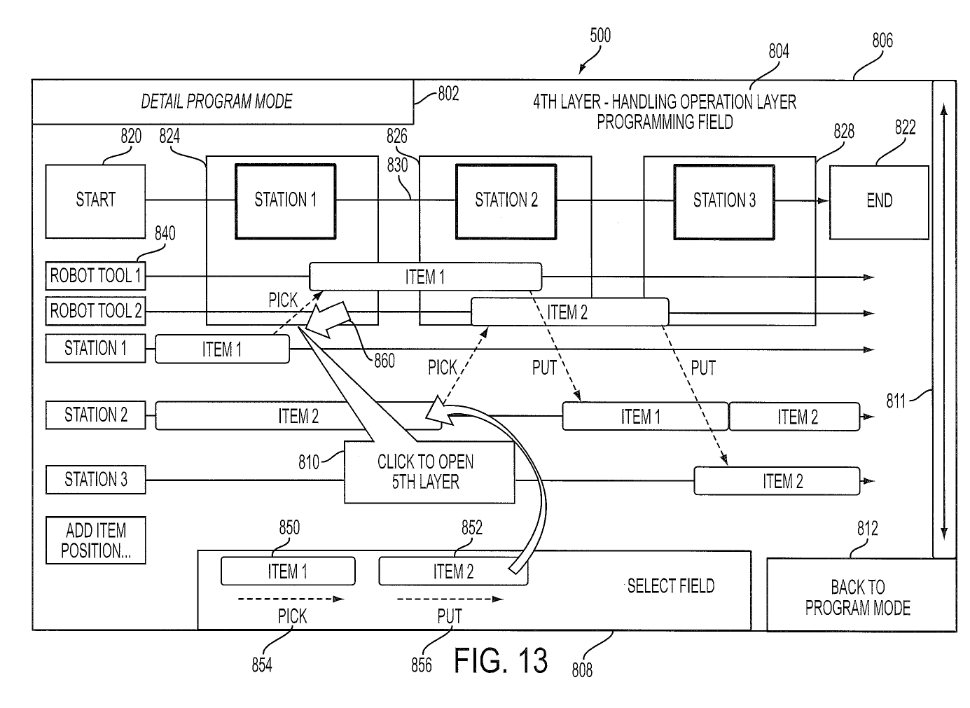

Once the 3^{rd} Layer or Processing Station Layer is defined by the user, then the user can proceed to define the other layers. For example, the user can return to the View Mode shown in FIG. 11 by selecting the Back to View Mode button 722, or the user can open the 4^{th} Layer by selecting the Detail Program Mode button 726. Then, the display 500 will display the 4^{th} Layer or Handling Operation Layer shown in FIG. 13.

The display 500 shown in FIG. 13 includes a mode indicia 802 indicating a mode that the display is currently in, and a layer indicia 804 including a label that describes a layer that is currently being displayed. In this depiction, the mode indicia 802 indicates a Detail Program Mode, which shows various display areas, and the layer indicia 804 indicates that a 4^{th} Layer or Handling Operation Layer with a Programming Field is being depicted.

The display 500 in FIG. 13 depicts the displays or areas as a programming field or area 806, and a selection field or area 808 labeled as a Select Field for the 4^{th} Layer.

The programming field 806 in FIG. 13 depicts a process timeline that corresponds to the timeline shown in the programming field 740 in FIG. 12. Thus, the programming field 806 has a start symbol or icon 820, a Station 1 box 824, a Station 2 box 826, a Station 3 box 828, and an end symbol or icon 822 along timeline 830. Each of the boxes 824, 826, and 828 provide an area in which the user can define the handling operations that are performed at or between the respective stations. At the left side of the programming field 806, a list 840 is provided of robot(s) or robot tool(s) that are available for use (e.g., Robot Tool 1, Robot Tool 2), and available handling operations (e.g., Handling Operation 1, Handling Operation 2, Handling Operation 3), and each of these icons is provided with a timeline that extends parallel to and corresponds to timeline 830.

The selection field 808 in FIG. 13 includes symbols or icons for selected items and for available handling operations. For example, the selection field includes an Item 1 symbol 850, and Item 2 symbol 852 (with a different visual effect from Item 1), a Pick (or pick-up operation) symbol 854 with a dashed line, and a Put (or put-down operation) symbol 856 with a dashed line (with a different visual effect from Pick). Thus, the user can select an item and/or a handling operation from the selection field 808 and insert the selection into the desired location in the programming field 806, for example, by dragging and dropping such selections. Thus, as can be seen in the examples in FIG. 13, Item 1 is defined as an item that is handled by being held at Station 1, picked-up by Robot Tool 1 (at Station 1), put-down by Robot Tool 1 (at Station 2), and changed to Item 2 by a machining operation (at Station 2), sequentially. Similarly, Item 2 is defined as an item that is handled by being held by Station 2, picked-up by Robot Tool 2 (at Station 2), Put-down by Robot Tool 2 (at Station 3), sequentially. In this manner, the user can easily and intuitively define the various handling operations performed on the selected items by selecting icons from the selection field 808 and inserting the selected icons in the programming field 806. The selected icons can be placed in the programming field 806 at the desired locations and can be elongated along the timeline as needed to correspond to the desired stations along timeline 830.

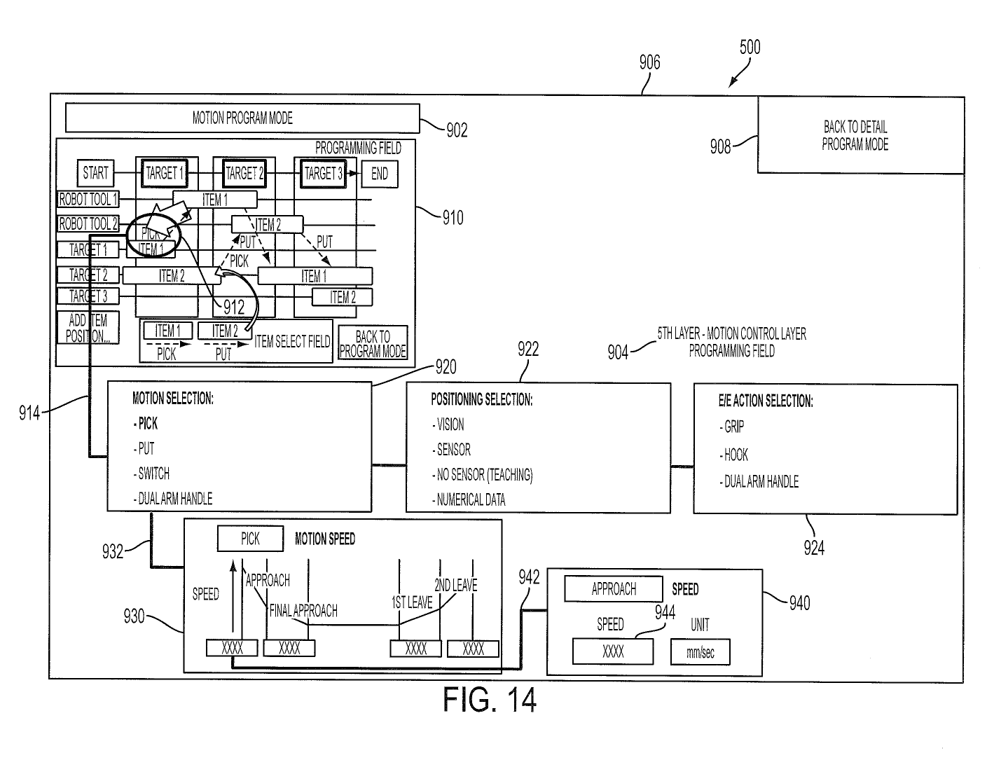

The display 500 in FIG. 13 includes a Back to Program Mode button 812 that can be selected by the user in order to go back to the display shown in FIG. 12. Also, the user can open a 5^{th} Layer, for example, by selecting a particular handling operation (e.g., using a mouse-controlled cursor 860, using a touchscreen, using another input device) or by selecting a dialogue box 810. Then, the display 500 will display the 5^{th} Layer or Motion Control Layer shown in FIG. 14.

It is noted that the display can include additional display effects. For example, display 500 in FIG. 13 includes a scroll bar 811 along a right edge thereof in order to allow a user to scroll up or down to show any additional items in the display. For example, the scroll bar 811 can be provided along an edge of the display when all of the timelines cannot fit within the display, or a scroll bar can be provided in the programming field (e.g., along a lower edge of the display in FIG. 12) to allow a user to scroll left and right to display all of the programming boxes when all of the boxes cannot fit within the display. Also, or alternatively, another display effect button could be provided that reduces the size of the depiction in the display in order fit all of the items in the display.

The display 500 shown in FIG. 14 includes a mode indicia 902 indicating a mode that the display is currently in, and a layer indicia 904 including a label that describes a layer that is currently being displayed. In this depiction, the mode indicia 902 indicates a Motion Program Mode, which shows various display areas, and the layer indicia 904 indicates that a 5^{th} Layer or Motion Control Layer with a Programming Field is being depicted.

The display 500 in FIG. 14 depicts a programming field or area 906, a Back to Detail Program Mode button 908 that will return the display to the display shown in FIG. 13, and a window 910 that depicts the selected handling operation of FIG. 13 in reduced size. The window 910 shows the selected handling operation of FIG. 13 with an indicia 912, which is, in this example, a circle formed about the selected handling operation and a leader line 914 that leads to several drop-down menus that can be used by the user to define motion control of the selected handling operation.

As depicted in FIG. 14, the window 910 shows the selected handling operation of FIG. 13 with indicia 912, and leader line 914 that leads to several drop-down menus that provide the user with selections and/or data entry areas for defining motion control of the selected handling operation. For example, a Motion Selection menu 920 is provided that indicates the selected “Pick” handling operation with a visual effect (e.g., bolded), and with a list of alternative selections for the user including a “Put” selection, a “Switch” selection (e.g., in which the robot switches items, switches hands, etc.), and a “Dual Arm Handle” selection (e.g., where the robot handles an item using two arms). The user can change the motion selection using the Motion Selection menu 920 if desired. A Positioning Selection menu 922 is provided that allows the user to define the manner in which the positioning is determined (e.g., using vision (e.g. camera), sensor, no sensor/teaching (e.g., the user manipulates the robot to teach the desired positions), or numerical data (e.g., entered by the user, or entered in conjunction with two-dimensional modeling or three-dimensional modeling data, etc.). A E/E (end effector) Action Section menu 924 is provided that allows the user to select a desired end effector for the robot to use during the handling operation, for example, a grip, hook, dual arm handle, etc.

Additionally, the Motion Selection menu 920 can also be provided with a drop-down Motion Speed window 930 connected by leader line 932. The Motion Speed window 930 allows the user to define in detail the motion performed during the selected motion (e.g., the “Pick” motion selected in the Motion Selection menu 920). For example, the Motion Speed window 930 shows a graph of the speed of the motion performed by the robot during the timeline of the “Pick” motion. The user can adjust the speed graph as desired. Also, Motion Speed window 930 can also be provided with a drop-down Speed window 940 connected by leader line 942 based on a selection of a speed along the graph. The Speed window 940 allows the user input desired speeds at different stages of the handling operation (e.g., during approach, final approach, first leave, second leave, etc.). The speed data can be entered by the user in speed box 944, using the desired units. In this manner, the user can easily and intuitively define the various handling operations performed on the selected items in detail.

Accordingly, a method and apparatus is provided that provides, on a user interface, symbols corresponding to input selections for teaching the industrial robot a processing operation, receives input, via the user interface, of selected symbols, and utilizes or compiles the input of the selected symbols to formulate the processing operation of the industrial robot. For example, the layering module 112 and the input/output module 114 of the processing unit 110 can present symbols corresponding to input selection on the display device 102 of the user interface 100 (e.g., as depicted in the displays in FIGS. 7-14). The processing unit 110 can then receive input of selected symbols via the input device(s) 104 of the user interface 100. For example, the calculation module 116 can receive the input data from the user interface 100, and utilize or compile the input data to formulate a processing operation. Such information can then be used to calculate movement of the robot(s). If desired, the calculation module 116 can also use the two-dimensional modeling or three-dimensional modeling data 122 during such calculations. For example, the processing unit 110 can be further configured to calculate movement of the industrial robot during the selected handling operation using predetermined two-dimensional modeling or three-dimensional modeling data in conjunction with the selected motion control. The control module 118 can then utilize the calculations performed by the calculation module 116 to control the robot(s) 130 during the processing operations.

Thus, the apparatus and method provide, on a user interface, symbols corresponding to input selections for teaching/programming an industrial robot a processing operation, which allows for complex teaching/programming in a simplified, intuitive, and easy-to-use manner

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A method for programming an industrial robot, said method comprising:
providing a processing operation that is divided into a plurality of layers; and
providing, via a processing unit, for selection among predetermined selections in each layer of the plurality of layers to program the processing operation.

2. The method according to claim 1, further comprising:
utilizing the selections in each layer of the plurality of layers to formulate the processing operation of the industrial robot.

3. The method according to claim 1,
wherein the plurality of layers includes a line layer including a plurality of manufacturing lines of a manufacturing plant, and
wherein the predetermined selections in the line layer includes the plurality of manufacturing lines.

4. The method according to claim 3,
wherein the plurality of layers includes an item layer including a plurality of items upon which the processing operation can be performed, and
wherein the predetermined selections in the item layer includes the plurality of items.

5. The method according to claim 4,
wherein the plurality of layers includes a processing station layer including a plurality of processing stations at which a predetermined processing operation is performed on a selected item of the plurality of items, and
wherein the predetermined selections in the processing station layer includes the plurality of processing stations.

6. The method according to claim 5, wherein each manufacturing line of the plurality of manufacturing lines includes a predetermined set of processing stations of the plurality of processing stations.

7. The method according to claim 5,
wherein the plurality of layers includes a handling operation layer including a plurality of handling operations that can be performed by the industrial robot on the selected item at a selected processing station, between selected processing stations, or between selected manufacturing lines, and
wherein the predetermined selections in the handling operation layer includes the plurality of handling operations that can be performed by the one or more industrial robots.

8. The method according to claim 7, wherein the handling operation layer is used to define a sequence of the plurality of handling operations that are performed by the industrial robot on the selected item.

9. The method according to claim 7,
wherein the plurality of layers includes a motion control layer including a plurality of motion controls that can be performed by the industrial robot during a selected handling operation of the plurality of handling operations, and
wherein the predetermined selections in the motion control layer includes the plurality of motion controls that can be performed by the industrial robot in order to perform the selected handling operation.

10. The method according to claim 9, further comprising:
providing, via the processing unit, for entry of input data in conjunction with the selected motion control to define movement of the industrial robot during the selected handling operation.

11. The method according to claim 9, further comprising:
calculating, using the processing unit, movement of the industrial robot during the selected handling operation using predetermined two-dimensional modeling or three-dimensional modeling data in conjunction with the selected motion control.

12. An apparatus for programming an industrial robot, said apparatus comprising:
a processing unit configured to provide a processing operation that is divided into a plurality of layers,
wherein the processing unit is configured to provide for selection among predetermined selections in each layer of the plurality of layers to program the processing operation.

13. An apparatus for programming an industrial robot, said apparatus comprising:
means for providing a processing operation that is divided into a plurality of layers; and
means for providing for selection among predetermined selections in each layer of the plurality of layers to program the processing operation.

14. A non-transitory computer readable medium storing a program which, when executed by one or more processing units, cause an apparatus to:
provide a processing operation that is divided into a plurality of layers; and
provide, via a processing unit, for selection among predetermined selections in each layer of the plurality of layers to program the processing operation.

15. A method for programming an industrial robot, said method comprising:
providing a processing operation that is divided into a plurality of categories; and providing, via a processing unit, for selection among predetermined selections in each category of the plurality of categories to program the processing operation.
